(19) United States
(12) Patent Application Publication
(10) Pub. No.: US 2014/0168585 A1
(43) Pub. Date: Jun. 19, 2014

(54) COLOR FILTER SUBSTRATE, MANFACTURING METHOD FOR THE SAME, AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Changgang Huang, Beijing (CN); Song Wang, Beijing (CN); Jiyu Wan, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/100,040

(22) Filed: Dec. 9, 2013

(30) Foreign Application Priority Data
Dec. 14, 2012 (CN) 201210546522.2

(51) Int. Cl. G02F 1/1335

(52) U.S. Cl. CPC G02F 1/133514; G02F 1/133516
USPC 349/106; 427/162

(57) ABSTRACT

An embodiment of the present invention relates to a color filter substrate, comprising: a transparent substrate, a black matrix unit being arranged on the transparent substrate, and color resin coatings. The black matrix unit may comprises first sub black matrices, being configured to be a forming foundation of the color resin coatings; and second sub black matrices, being configured to be on the first sub black matrices, and be filled between the color resin coatings after the color resin coatings have been formed. At least a portion of the first sub black matrices are covered by the color resin coatings formed after the first sub black matrices are formed. And a sum of a thickness of the first sub black matrix and a thickness of the second sub black matrix is not less than a minimum thickness value satisfying a shading requirement.

### CROSS-REFERENCE TO RELATED APPLICATIONS

This application claims priority to Chinese Patent application No. 201210546522.2, filed Dec. 14, 2012, which is hereby incorporated by reference in its entirety.

### TECHNICAL FIELD

The present invention relates to the technical field of liquid crystal displaying, and more particularly to a color filter substrate, a manufacturing method for the same and a display device.

### BACKGROUND

The color filter substrate is a component necessary for the liquid crystal display (LCD). A traditional color filter substrate is generally consisted of a transparent substrate 1, a black matrix (BM) unit 3, color resin coatings 4, an over coating (OC) 5 and a post spacer (PS) 6 (as illustrated in FIG. 1). An angular segment difference h exists at a position where the color resin coating 4 and the BM unit 3 are intersected (a region of the angular segment difference is the region indicated by a circle as illustrated in FIG. 1). Such an angular segment difference is required to be flattened by the over coating 5. The thickness of the BM unit 3 is in proportional to its optical density (OD) value. If the OD value of the BM unit 3 is too thin, there will be a risk of light leaking; and if the BM unit 3 is too thick, the angular segment difference h at the position corresponding to the color resin coating 4 will be increased.

In the conventional color filter substrate, the BM unit 3 is directly prepared on the transparent substrate 1, the thickness is usually 1.1˜1.5 um, which is substantially half of the thickness of the color resin coating 4. During a process of preparing a color filter substrate having such a structure, since the BM unit 3 is too thick, it is vulnerable that a relatively large angular segment difference exists at the position where the color resin coating 4 and the BM unit 3 are intersected during the preparation process.

So far the advanced generation production line usually uses ink jet device to coat a polyimide (PI) coating on the surface of the substrate (an orientation coating, being configured to arrange the liquid crystals between the color filter substrate and the array substrate according to certain rules). Such process has a high requirement on flatness of the surface of the substrate. When the angular segment difference of the color filter substrate is too large while the over coating is too thin, it is still easily to cause defects such as holiday defect and uneven distribution of PI upon being coated even it has been flattened by the over coating 5. And thus the thickness of the over coating is increased and the cost rises.

### SUMMARY

For solving the above technical problem, the embodiments of the present invention provide a color filter substrate, a manufacturing method for the same and a display device for reducing the angular segment difference at a position where the color resin coating and the BM unit are intersected.

For achieving the above object, an embodiment of the present invention adopts a technical solution as follows: a color filter substrate may comprise: a transparent substrate, a black matrix unit being arranged on the transparent substrate, and color resin coatings, wherein the black matrix unit comprises:

first sub black matrices, being configured to be a forming foundation of the color resin coatings; and second sub black matrices, being configured to be on the first sub black matrices, and be filled between the color resin coatings after the color resin coatings have been formed;

wherein at least a portion of the first sub black matrices are covered by the color resin coatings formed after the first sub black matrices are formed; and

wherein a sum of a thickness of the first sub black matrix and a thickness of the second sub black matrix is not less than a minimum thickness value satisfying a shading requirement.

Furthermore, the thickness of the first sub black matrix may be less than 0.5 um.

Furthermore, the thickness of the black matrix unit may be less than the thickness of the color resin coating, and

wherein an over coating is further arranged on the transparent substrate for eliminating a segment difference of the color resin coatings and an angular segment difference between the color resin coating and the black matrix unit.

Furthermore, the thickness of the over coating may be less than 1 um.

Furthermore, it may also comprise a post spacer being arranged on the over coating.

Furthermore, the thickness of the black matrices unit may equal to the thickness of the color resin coating.

Furthermore, it may also comprise a shielding protection coating, being configured to be arranged on a side of the transparent substrate that is opposite to the black matrix unit and the color resin coating.

Another embodiment of the present invention provides a display device comprising the color filter substrate as described above.

Another embodiment of the present invention also provides a manufacturing method for the color filter substrate, comprising the following steps:

forming a pattern of a first sub black matrices on a side of a transparent substrate;

forming color resin coatings corresponding to aperture areas of the pattern of the first sub black matrices on the pattern of the first sub black matrices, wherein at least a portion of a reserved area of the pattern of the first sub black matrices is covered by the color resin coatings; and

forming a pattern of second sub black matrices, wherein a reserved area of the pattern of the second sub black matrices are arranged on a non-reserved area of the color resin coatings.

Furthermore, when the thickness of the color resin coating is greater than a sum of the thickness of the pattern of the first sub black matrix and the thickness of the second sub black matrix, it may further comprise the following steps:

forming an over coating on the color resin coating and the pattern of the second sub black matrices.

Furthermore, it may also comprise the following step:

forming a post spacer on the over coating.

Furthermore, it may also comprise the following step:

forming a shielding protection coating on a side of the transparent substrate that is opposite to the black matrix unit and the color resin coating.

The technical effects of the present invention lie in that: the angular segment difference between the color resin coating and the black matrix unit is reduced; the distribution evenness of the liquid crystal orientation coating is improved; the thickness of the over coating is reduced; and the cost is saved.

### DESCRIPTION OF THE DRAWINGS

The present invention will be more clearly understood from the description of preferred embodiments as set forth below, with reference to the accompanying drawings, wherein:

FIG. 1 illustrates a structure diagram of a color filter substrate according to the prior art;

FIG. 2 illustrates a structure diagram of a color filter substrate according to an embodiment of the present invention;

FIG. 3 illustrates a diagram of the color filter substrate after a shielding protection coating has been prepared according to an embodiment of the present invention;

FIG. 4 illustrates a diagram of the color filter substrate after a first sub black matrix pattern has been prepared according to an embodiment of the present invention;

FIG. 5 illustrates a diagram of the color filter substrate after a red sub pixel region has been prepared according to an embodiment of the present invention;

FIG. 6 illustrates a diagram of the color filter substrate after a green sub pixel region has been prepared according to an embodiment of the present invention;

FIG. 7 illustrates a diagram of the color filter substrate after a blue sub pixel region has been prepared according to an embodiment of the present invention;

FIG. 8 illustrates a diagram of the color filter substrate after the second sub black matrix pattern has been prepared according to an embodiment of the present invention;

FIG. 9 illustrates a diagram of the color filter substrate after an over coating has been prepared according to an embodiment of the present invention;

FIG. 10 illustrates a diagram of the color filter substrate after a post spacer has been prepared according to an embodiment of the present invention; and

FIG. 11 illustrates a flow chart of the manufacturing procedure of the color filter substrate according to an embodiment of the present invention.

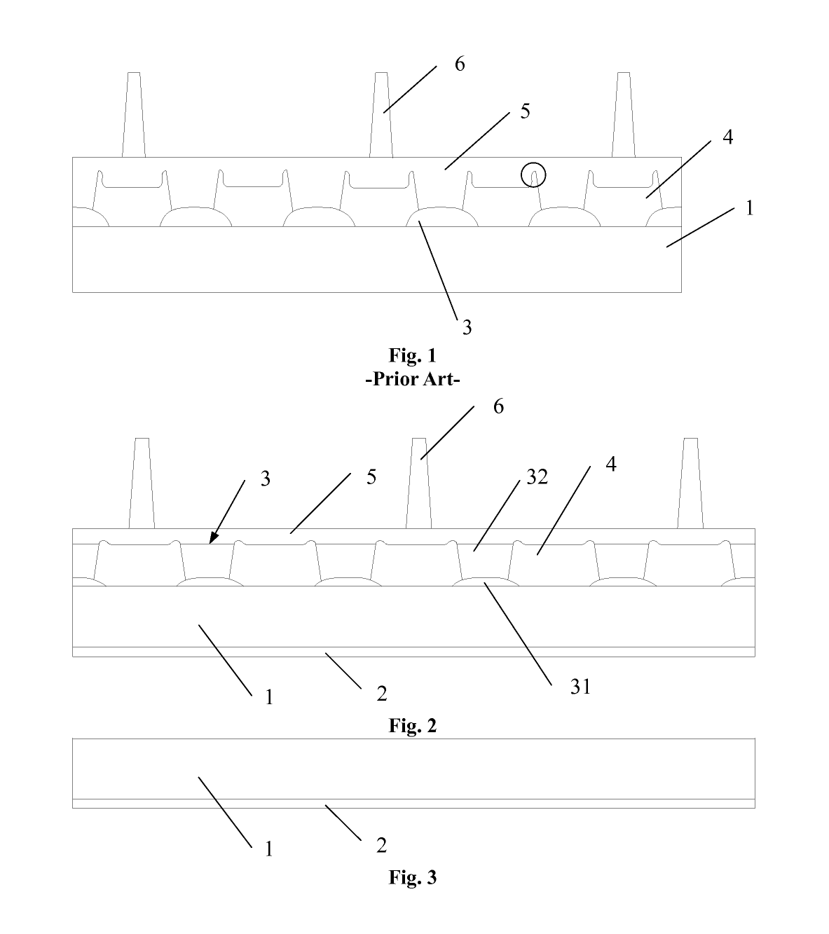

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

In the following, the structure and principle of the embodiments of the present invention will be further explained in details in association with the figures. The embodiments herein are only used to explain the present invention, and are not used to limit the protection scope of the present invention.

As illustrated in FIG. 2, a color filter substrate comprises: a transparent substrate 1, a black matrix unit 3 being arranged on the transparent substrate 1, and color resin coatings 4. And the black matrix unit 3 comprises:

first sub black matrices 31, being configured to be a forming foundation of the color resin coatings 4; and second sub black matrices 32, being configured to be on the first sub black matrices 31, and be filled between the color resin coatings 4 after the color resin coatings 4 have been formed;

at least a portion of the first sub black matrices 31 are covered by the color resin coatings 4 formed after the first sub black matrices 31 are formed. And a sum of a thickness of the first sub black matrix 31 and a thickness of the second sub black matrix 32 is not less than the minimum thickness value satisfying a shading requirement.

In the prior arts, the black matrix unit is one time formed on the transparent substrate 1. And the thickness of the black matrix unit is not less than the minimum thickness value satisfying the shading requirement. Thus a relatively large angular segment difference is generated at the position where the color resin coating 4 and the black matrix unit are intersected. By contrast, in this embodiment, the black matrix unit 3 may comprise first sub black matrices 31 and second sub black matrices 32 which are respectively formed by two different processes; and the sum of the thickness of the first sub black matrix 31 and the thickness of the second sub black matrix 32 is not less than the minimum thickness value satisfying the shading requirement; furthermore, only at least a portion of the first sub black matrices 31 are covered by the color resin coating 4, and the second sub black matrices 32 are arranged between the color resin coatings 4, so that the shading performance of the black matrix unit 3 is ensured, and no larger angular segment difference is generated on the color resin coating 4.

It can be seen from above that, the thickness of the first sub black matrix 31 is significantly reduced by comparing with the thickness of the black matrix in the prior arts. And thus the angular segment difference L between the color resin coating 4 and the black matrix unit 3 is reduced, so that the angular segment difference being generated by intersecting of the color resin coating 4 and the first sub black matrix unit 31 is reduced. The coordination of the first sub black matrices 31 and the second sub black matrices 32 ensures the shading performance of the black matrix unit 3, which reduces the thickness of the over coating 5 for eliminating the angular segment difference L between the color resin coating 4 and the black matrix unit 3, saves cost, does not affect the OD value of the black matrix unit 3, and nor causes the optical leaking phenomenon.

Preferably, the thickness of the first sub black matrices 31 is less than 0.5 um (herein the thickness of the first sub black matrices 31 is an average thickness), but not limited to this value range, so that the angular segment difference caused by the intersection portion of the black matrix unit 3 and the color resin coating 4 is less than 0.05 um.

When the thickness of the black matrix unit 3 is less than the thickness of the color resin coating 4, an over coating 5 may be further arranged on the transparent substrate 1 for eliminating a segment difference of the color resin coating 4 and an angular segment difference L between the color resin coating 4 and the black matrix unit 3.

Because the provision of the first sub black matrices 31 causes that only a very small angular segment difference is generated by the portion covered by the color resin 4 on the black matrix unit 3, the second sub black matrices 32 and the first sub black matrices 31 coordinate, so that the thickness of the over coating is less than 1 um.

When the thickness of the black matrix unit 3 equals to the thickness of the color resin coating 4, and the thickness of the first sub black matrices is sufficiently thin resulting in that the angular segment difference of the color resin coat 4 may be neglected, it is possible not to arrange the over coating 5. As a result, the flattening process is omitted in the manufacturing procedure; the complexity of the manufacturing process is reduced; the processing duration is shortened; and the operation efficiency is improved.

In this embodiment, the color filter substrate with the over coating 5 being arranged may further comprise a post spacer 6 being arranged on the over coating 5.

When the material of the post spacer 6 is transparent material, the position of the post spacer 6 is not particularly limited, which may be arranged on the color resin coating 5 as illustrated in FIG. 2. When the material of the post spacer 6 is non-transparent material, it is necessary to arrange the post spacer 6 over the black matrix unit 3, so as not to affect the displaying effect.

Preferably, as illustrated in FIG. 2, the color filter substrate may further comprise a shielding protection coating 2, which is arranged on a side of the transparent substrate 1 that is opposite to the black matrix unit 3 and the color resin coating 4.

Here, the shielding protection coating 2 is a transparent shielding protection film, the material thereof may be indium tin oxide (ITO), which is not limited thereto. The shielding protection coating mainly functions to shield the static electricity and to protect the display panel from the affection by an external electric field. For a twisted nematic (TN) LCD apparatus, since a common electrode film coating is arranged on the color filter substrate of such TN LCD apparatus and the common electrode film coating may function to shield static electricity, it is possible for the color filter substrate to comprise or not to comprise the shielding protection film coating. For the advanced super dimension switch (ADS or AD-SDS) LCD apparatus, since its common electrode is arranged on the array substrate, it is preferable for the surface of the color filter substrate to comprise the shielding protection coating.

Here, the ADS may form a multi-dimensional electric field mainly by an electric field generated by a slit electrode edge on a same plane and an electric field generated between a slit electrode coating and a plate electrode coating, so that each of all oriented liquid crystal molecules between the slit electrodes in each liquid crystal cell and just above the electrodes may result in a rotation, and thus the operation efficiency of the liquid crystals is improved and the light transmission efficiency is increased. The ADS may improve the image quality of a TFT-LCD product, and has the advantages of high resolution, high transmittance, low power consumption, wide viewing angle, high aperture ratio, low chromatic aberration, push Mura free, and, etc.

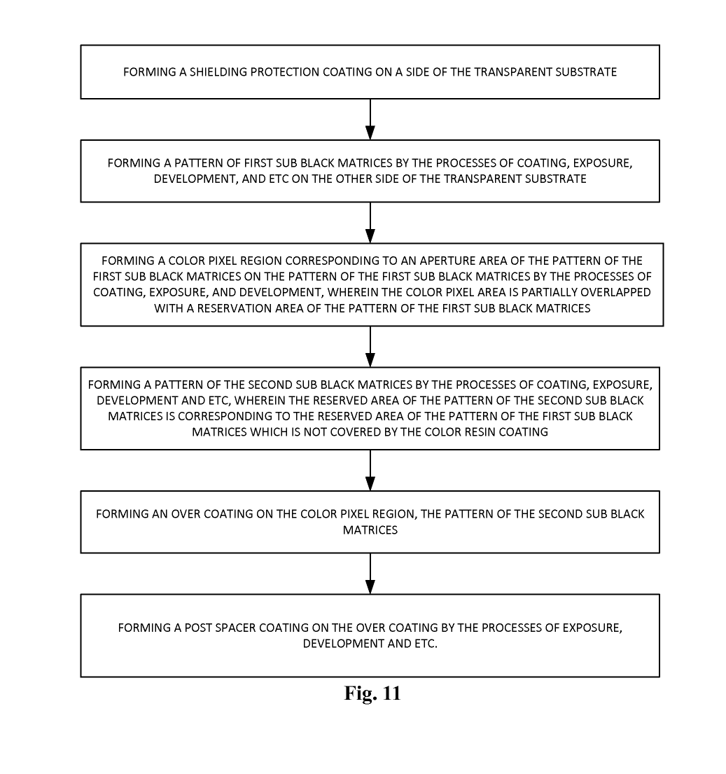

As illustrated in FIG. 11, another embodiment of the present invention also provides a manufacturing method for the color filter substrate, comprising the following steps:

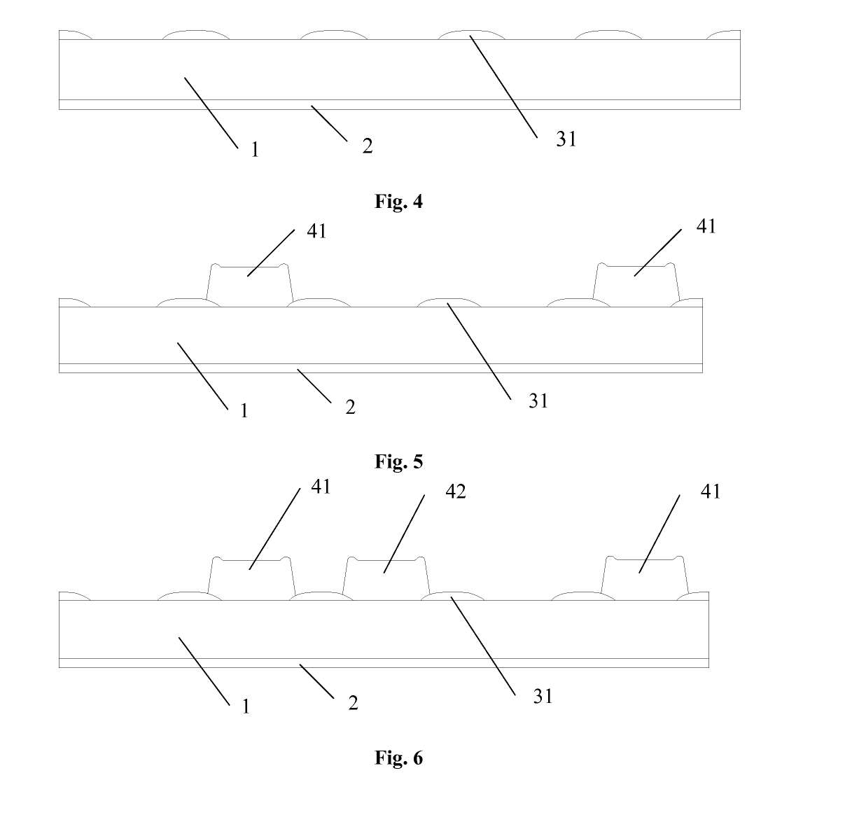

step 1: forming a pattern of first sub black matrices on a side of the transparent substrate, and the color filter substrate after the pattern of the first sub black matrices is illustrated in FIG. 4;

step 2: forming color resin coatings corresponding to aperture areas of the pattern of the first sub black matrices on the pattern of the first sub black matrices, wherein at least a portion of a reserved area of the pattern of the first sub black matrices is covered by the color resin coatings; and

step 3: forming a pattern of second sub black matrices, wherein a reserved area of the pattern of the second sub black matrices are arranged on a non-reserved area of the color resin coatings, i.e. the reserved area of the pattern of the second sub black matrices corresponds to the reserved area of the pattern of the first sub black matrices which is not covered by the color resin coating; and the color filter substrate after the pattern of the second sub black matrices has been prepared is illustrated in FIG. 8.

The first sub black matrices 31, the color resin coating 4, and the second sub black matrices 32 are all prepared by such processes as film coating, exposure, development, and etc. known in the prior arts, and the description thereof is omitted herein.

Preferably, when the thickness of the color resin coating is less than a sum of the thickness of the reserved area of the pattern of the first sub black matrices and the thickness of the reserved area of the pattern of the second sub black matrices, it further comprises the following step:

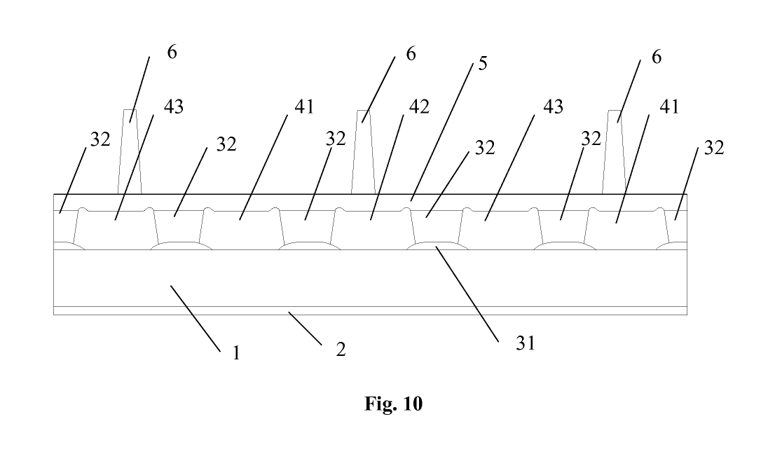

step 4: forming an over coating on the color resin coatings and the pattern of the second sub black matrices, wherein the color filter substrate after the over coating has been prepared is illustrated in FIG. 9.

The formation of the over coating on the color resin coating and the pattern of the second sub black matrices is implemented by such processes as film coating, sputtering, deposition or etc., known in the prior arts, and the description and limitation thereof is omitted herein.

Furthermore, it may further comprise:

step 5: forming a post spacer on the over coating by the processes of exposure and development, wherein the color filter substrate after the post spacer has been prepared is illustrated in FIG. 10.

Here, the post spacer 6 and the over coating 5 may be integrally formed or respectively formed.

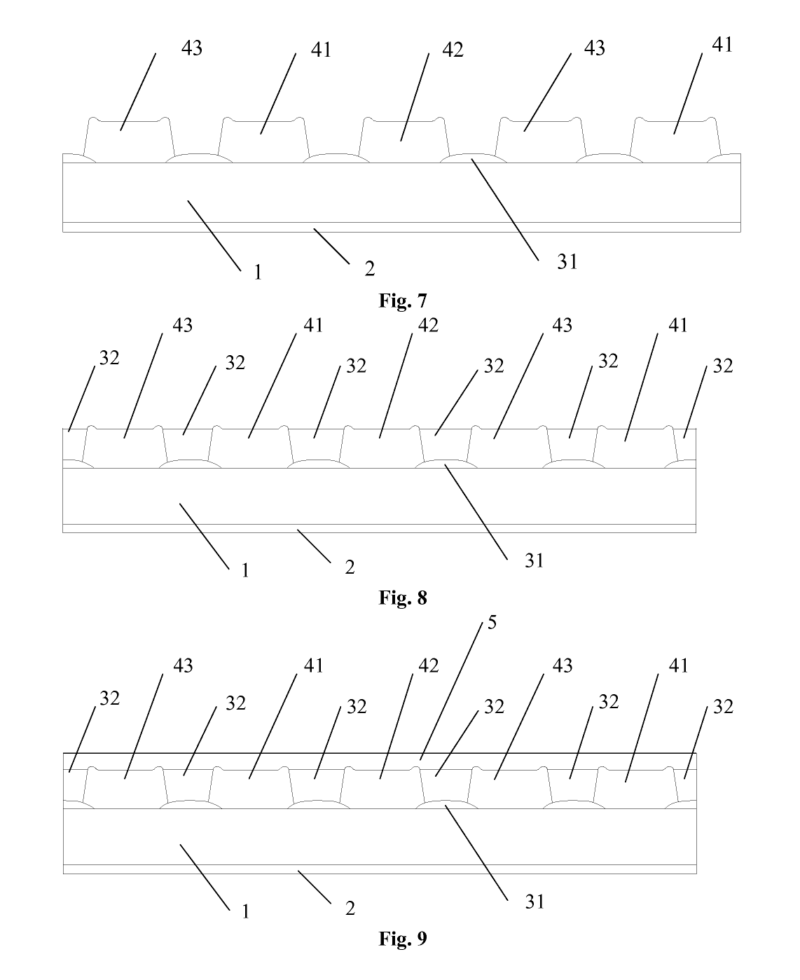

In step 2, the color resin coating 4 comprises a red sub pixel region, a green sub pixel region and a blue sub pixel region, but is not limited thereto. Specifically, it may select a sub pixel region in other color or further comprise a sub pixel region in other color such as a yellow sub pixel region, a white sub pixel region on top of the above-described red sub pixel region, the green sub pixel region and the blue sub pixel region as needed. Here, for example, it is assumed that the color resin coating 4 has three colors in this embodiment. The color resin coating 4 comprises the red sub pixel region 41, the green sub pixel region 42 and the blue sub pixel region 43. During the formation, firstly the red sub pixel region 41 is formed, the color filter substrate after the red sub pixel region has been prepared is illustrated in FIG. 5; then the green sub pixel region 42 is formed, the color filter substrate after the green sub pixel region has been prepared is illustrated in FIG. 6; finally the blue sub pixel region 43 is formed, the color filter substrate after the blue sub pixel region has been prepared is illustrated in FIG. 7.

Obviously that in the above manufacturing method for the three sub pixel regions in red, green and blue, the formation sequence of the red sub pixel region, the green sub pixel region and the green sub pixel region may be arbitrarily changed, which is not limited thereto.

In this embodiment, the formation of the color filter substrate is implemented by the processes known in the prior arts, and the description thereof is omitted herein.

Furthermore, based on the above manufacturing method for the color filter substrate, it may further comprise:

step 6: forming a shielding protection coating on a side of the transparent substrate that is opposite to the black matrix unit and the color resin coating, wherein the color filter substrate after the shielding protection coating has been prepared is illustrated in FIGS. 3-10. Specifically, the shielding protection coating may be implemented by such processes as deposition, sputtering and etc., known in the prior arts, and the description and limitation thereof is omitted herein.

Furthermore, since the shielding protection coating is arranged on the side of the transparent substrate that is opposite to the black matrix unit and the color resin coating, which is irrelevant to steps 1-5. Thus step 6 may be independently implemented. Preferably, the implementation of step 6 is before the implementation of step 1.

The embodiment of the present invention also provides a display device, including any of the color filter substrates as described above. The display device may be any product or part that has a display function, such as an LCD panel, a mobile phone, a tablet computer, a television, a monitor, a notebook computer, a digital photo frame, a navigator and so on.

The above descriptions are only preferred embodiments of the present invention. It should be noted that, for those ordinary skilled in the art, many modifications and polishes may be made without departure from the principles of the present invention, and these modification and polishes should also be deemed to be fallen into the protection scope of the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A color filter substrate, comprising: a transparent substrate, a black matrix unit being arranged on the transparent substrate, and color resin coatings, wherein the black matrix unit comprises:
first sub black matrices, being configured to be a forming foundation of the color resin coatings; and second sub black matrices, being configured to be on the first sub black matrices, and be filled between the color resin coatings after the color resin coatings have been formed;
wherein at least a portion of the first sub black matrices are covered by the color resin coatings formed after the first sub black matrices are formed; and
wherein a sum of a thickness of the first sub black matrix and a thickness of the second sub black matrix is not less than a minimum thickness value satisfying a shading requirement.

2. The color filter substrate according to claim 1, wherein the thickness of the first sub black matrix is less than 0.5 um.

3. The color filter substrate according to claim 2, wherein the thickness of the black matrix unit is less than the thickness of the color resin coating; and
wherein an over coating is further arranged on the transparent substrate for eliminating a segment difference of the color resin coatings and an angular segment difference between the color resin coating and the black matrix unit.

4. The color filter substrate according to claim 3, wherein the thickness of the over coating is less than 1 um.

5. The color filter substrate according to claim 4, further comprising a post spacer, being configured to be arranged on the over coating.

6. The color filter substrate according to claim 2, wherein the thickness of the black matrix unit equals to the thickness of the color resin coating.

7. The color filter substrate according to claim 1, further comprising a shielding protection coating, being configured to be arranged on a side of the transparent substrate that is opposite to the black matrix unit and the color resin coating.

8. The color filter substrate according to claim 2, further comprising a shielding protection coating, being configured to be arranged on a side of the transparent substrate that is opposite to the black matrix unit and the color resin coating.

9. The color filter substrate according to claim 3, further comprising a shielding protection coating, being configured to be arranged on a side of the transparent substrate that is opposite to the black matrix unit and the color resin coating.

10. The color filter substrate according to claim 4, further comprising a shielding protection coating, being configured to be arranged on a side of the transparent substrate that is opposite to the black matrix unit and the color resin coating.

11. The color filter substrate according to claim 5, further comprising a shielding protection coating, being configured to be arranged on a side of the transparent substrate that is opposite to the black matrix unit and the color resin coating.

12. A display device, comprising the color filter substrate according to claim 1.

13. The display device according to claim 12, wherein the thickness of the first sub black matrix is less than 0.5 um.

14. The display device according to claim 13, wherein the thickness of the black matrix unit is less than the thickness of the color resin coating; and
wherein an over coating is further arranged on the transparent substrate for eliminating a segment difference of the color resin coating and an angular segment difference between the color resin coating and the black matrix unit.

15. The display device according to claim 14, wherein the thickness of the over coating is less than 1 um.

16. The display device according to claim 15, further comprising a post spacer, being configured to be arranged on the over coating.

17. A manufacturing method for a color filter substrate, comprising the following steps:
forming a pattern of first sub black matrices on a side of a transparent substrate;
forming color resin coatings corresponding to aperture areas of the pattern of the first sub black matrices on the pattern of the first sub black matrices, wherein at least a portion of a reserved area of the pattern of the first sub black matrices is covered by the color resin coatings; and
forming a pattern of second sub black matrices, wherein a reserved area of the pattern of the second sub black matrices are arranged on a non-reserved area of the color resin coatings.

18. The manufacturing method for the color filter substrate according to claim 17, further comprising the following step, when the thickness of the color resin coating is greater than a sum of the thickness of the pattern of the first sub black matrix and the thickness of the second sub black matrix:
forming an over coating on the color resin coatings and the pattern of the second sub black matrices.

19. The manufacturing method for the color filter substrate according to claim 18, further comprising the following step:
forming a post spacer on the over coating.

20. The manufacturing method for the color filter substrate according to claim 17, further comprising the following step:
forming a shielding protection coating on a side of the transparent substrate that is opposite to the black matrix unit and the color resin coating.
